(19) United States
(12) Patent Application Publication
(10) Pub. No.: US 2026/0353174 A1
(43) Pub. Date: Nov. 5, 2026

(54) QUALITY OF SERVICE MONITORING EXTENSIONS

(71) Applicant: Telefonaktiebolaget LM Ericsson (publ), Stockholm (SE)

(72) Inventors: Maria Luisa MAS ROSIQUE, Tres Cantos, Madrid (ES); Susana FERNANDEZ ALONSO, Madrid (ES); Fuencisla GARCIA AZORERO, Madrid (ES); Julian ESPINOSA SANTOS, Madrid (ES); Miguel Angel MUÑOZ DE LA TORRE ALONSO, Madrid (ES)

(21) Appl. No.: 19/486,778

(22) PCT Filed: May 22, 2024
(86) PCT No.: PCT/IB2024/054995

§ 371 Date: Nov. 21, 2025

(30) Foreign Application Priority Data
May 22, 2023 (EP) 23382472.1

(51) Int. Cl. H04W 28/02; H04L 12/14

(52) U.S. Cl. CPC H04W 28/0268; H04L 12/1407

(57) ABSTRACT

A method in a first core network node configured to communicate with a second core network node is described. The method includes receiving, from the second core network node, a subscription request for subscribing to a Quality of Service (QOS) Monitoring event for a QoS flow bound to an application. The subscription request includes an indication to receive a QoS monitoring report on a QOS flow associated with a default QoS rule in the event no Policy Control Charging (PCC) rule is identified for the application or no PCC rule with QoS monitoring enabled is found for the application. The method also includes configuring a third core network node serving as a User Plane Function (UPF) to include in the QOS Monitoring report an indication indicating that QoS monitoring is performed on the QoS flow associated to the default QoS rule.

### TECHNICAL FIELD

The present disclosure relates to wireless communications, and in particular, to configurations for supporting enhanced quality of service (QOS) monitoring.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)) wireless communication systems, and Sixth Generation (6G) wireless communication networks. Such systems provide, among other features, broadband communication between network nodes, such as base stations, and mobile wireless devices (WD)(which may include a user equipment (UE)), as well as communication between network nodes and between WDs. The terms WD and UE may be used interchangeably in the present disclosure.

FIG. 1 is a schematic diagram which illustrates an example 5G reference non-roaming architecture as defined by 3GPP.

Some example architectural aspects of 5G include:
Network Data Analytics Function (NWDAF)
Application Function (AF)
Unified Data Management (UDM)
Policy Control Function (PCF)
Session Management Function (SMF)
User Plane Function (UPF)

One or more of the above functions may be implemented in, e.g., a network node, core network node, base station, core node, virtual node, server, host computer, cloud node, cloud server, data center, etc.

### NWDAF

In some systems, NWDAF represents an operator managed network analytics logical function. The NWDAF is part of some 5GC architectures and uses the mechanisms and interfaces specified for 5GC and operations, administration, and maintenance (OAM).

The NWDAF interacts with different entities for various purposes:
Data collection based on event subscription, provided by AMF, SMF, PCF, UDM, AF (directly or via Network Exposure Function (NEF)), and OAM;
Retrieval of information from data repositories (e.g., Unified Data Repository (UDR) via UDM for subscriber-related information);
Retrieval of information about NFs (e.g., NRF for NF-related information, and NSSF for slice-related information);
On demand provision of analytics to consumers.
Storage in Analytics Data Repository Function (ADRF) for two types of data:
   Collected Data (e.g., Event Exposure data).
   Analytics reports.

### AF

The AF in some existing systems interacts with the 3GPP Core Network and may allow external parties to use the Exposure Application Programming Interfaces (APIs) offered by the network operator.

### UDM

The UDM includes support for the following functionality:
Generation of 3GPP Authentication and Key Agreement (AKA) Authentication Credentials.
User Identification Handling (e.g., storage and management of Subscription Permanent Identifier (SUPI) for each subscriber in the 5G system).
Support of de-concealment of privacy-protected subscription identifier (SUCI).
Access authorization based on subscription data (e.g., roaming restrictions).
WDs (UE's) Serving NF Registration Management (e.g., storing serving AMF for WDs (UEs), storing serving SMF for WDs (UE's) Packet Data Unit (PDU) Session).
Support to service/session continuity, e.g., by keeping SMF/DNN assignment of ongoing sessions.
Mobile Terminated Short Message Service (MT-SMS) delivery support.
Lawful Intercept Functionality (e.g., in outbound roaming case where UDM is the only point of contact for Lawful Intercept (LI)).
Subscription management.
SMS management.
5G Virtual Network (5G-VN) group management handling.
Support of external parameter provisioning (Expected WD (UE) Behaviour parameters or Network Configuration parameters).
Support for the Disaster Roaming.
Support for the control of time synchronization service based on subscription data.

To provide these functionalities, the UDM may use subscription data (including authentication data) that may be stored, e.g., in UDR, in which case a UDM implements the application logic and does not require internal user data storage. Several different UDMs may serve the same user in different transactions.

### PCF

In some existing systems, the Policy Control Function (PCF) supports a unified policy framework to govern the network behavior. Specifically, the PCF provides Policy and Charging Control (PCC) rules to the PCEF (Policy and Charging Enforcement Function), i.e., the SMF/UPF that enforces policy and charging decisions according to provisioned PCC rules.

The PCF may generate the authorized QoS Monitoring policy for a service data flow based on the QoS Monitoring request received from the AF (as described in 3GPP standards such as, for example, clause 6.1.3.21 of 3GPP TS 23.503). The PCF includes the authorized QoS Monitoring policy in the PCC rule and provides it to the SMF.

### SMF

In some existing systems, the Session Management function (SMF) supports different functionalities, e.g., SMF receives PCC rules from the PCF and configures the UPF accordingly.

The SMF configures the UPF to perform QoS monitoring for the QoS Flow and to report the monitoring results with parameters determined by the SMF based on the authorized QoS Monitoring policy received from the PCF and/or local configuration.

### UPE

In some existing systems, the User Plane function (UPF) supports handling of user plane traffic, including packet inspection, packet routing and forwarding, traffic usage reporting, QoS handling.

The UPF supports event exposure, including exposure of network information, i.e., the QoS monitoring information, as specified in 3GPP standard(s) such as, for example, 3GPP TS 23.501, clause 5.8.2.18, events as specified in 3GPP standard(s) such as, for example, clause 5.2.26.2 of 3GPP TS 23.502V18.5.0.

The following problems are identified in some existing systems:
When a consumer (e.g., NWDAF) subscribes to QoS Monitoring event for a certain application, an error is returned in case the PDU session has not installed a PCC rule for that application with QOS Monitoring policy (i.e., QoS monitoring is not enabled for that application). This error means that the subscription has not been created and thus the NF consumer needs to send a new subscription to monitor the application traffic:
   If the consumer (e.g., NWDAF) deducts the application traffic that is being sent through the QoS flow associated to the default QoS rule, it can initiate a new subscription for that QoS Flow. But:
      Measuring some QoS parameters on that QoS Flow may not be significant (e.g., data rates are measured considering all applications sharing the QoS Flow).
      The consumer assumption may not be correct: the application traffic may not be running on that QoS flow if a PCC rule with QoS requirements but without QoS monitoring policy has bound the application traffic to another QoS Flow. NWDAF should not subscribe, since the measurements will not correspond to the application traffic.
   If the consumer does not initiate a new subscription immediately but it decides to wait, there is no mechanism for the consumer to know when the corresponding PCC rule with QoS monitoring policy is installed (i.e., when the application traffic is bound to a dedicated QoS flow with QoS monitoring enabled). It is unclear how the new subscription is triggered in the consumer.
In addition, when the consumer (e.g., NWDAF) has sent the original subscription indirectly via UDM (e.g., for a user or group of users rather than a specific PDU Session), and the error is returned to UDM:
   if UDM does not create the subscription and returns that error to the consumer, the error in one PDU Session will affect the subscription to all other PDU Sessions of the target user or group of users.
   If UDM creates the subscription and does not send the error to the consumer, UDM inherits the responsibility of resending the subscription for the specific PDU Session (the error indicates the subscription has not been created by the service producer) and UDM inherits the problems described above.

### SUMMARY

Some embodiments advantageously provide methods, systems, and apparatuses supporting enhanced quality of service QoS monitoring.

Some embodiments of the present disclosure provide a mechanism, method, apparatus, etc., which may solve one or more of the above-identified problems with existing systems, which may be based on an enhancement of the existing mechanisms for QoS monitoring, and/or which may enable the mobile network operator (MNO) to optimize network resources by, for example:
A consumer (e.g., NWDAF, which may be implemented for example in a core network node with NWDAF, or any other core network node) being configured to include in the subscription to QoS Monitoring event for a certain application information (e.g., indication, message, signaling, etc.) corresponding to and/or including fallback instructions, e.g., for a case where the PDU session does not have an installed PCC rule for that application with QoS Monitoring enabled.
A provider (i.e., SMF, which may be implemented for example in a core network node with SMF) may be configured for creating the subscription and proceeding as in fall back instructions and towards NG-RAN (e.g., a network node in access network) and/or UPF (e.g., which may be implemented in a core network node with UPF) as applicable, including, for example:
   Activating QOS Monitoring on the QoS Flow associated to the default QoS Rule; and/or
   Creating the subscription and/or triggering the monitoring once a PCC rule is installed that has QoS Monitoring enabled.
In some embodiments, QoS Monitoring reports may include an indication of whether the QoS monitoring has been performed on the QoS Flow associated to the default QoS rule, which may be an alternative to QoS monitoring on a QoS flow bound to the PCC rule for that application with a QoS monitoring policy.

Some embodiments of the present disclosure provide an extension of QoS Monitoring procedures, e.g., which may allow and/or configure the consumer (e.g., NWDAF, which may be implemented for example in a core network node with NWDAF) delegate the decision of what to do in case of an error (e.g., activate QoS monitoring for the QoS flow associated to the default QoS rule), and/or which enables the consumer to determine if the QoS Monitoring reports refer to the QoS flow for the default QoS rule or a QoS flow dedicated to the application triggered by a PCC rule with QoS Monitoring enabled provided by the PCF (e.g., implemented in a core network node with PCF).

Embodiments of the present disclosure may provide one or more of the following advantages over existing systems:
Some embodiments may enable the network operator to optimize network resources in an efficient, streamlined way, by, for example:
   Implementation of consumers may be streamlined and more efficient compared to existing systems.
   Consumers (e.g., NWDAFs, which may be implemented for example in a core network node with NWDAF) may still control fallback (e.g., QoS Monitoring may be performed on the QoS Flow associated to the default QoS rule only when those measurements are relevant for the consumer), but it delegates the subscription re-activation to the SMF (e.g., implemented in a core network node including SMF).
      In some embodiments, a consumer may be configured for indicating whether to allow, as a fallback mechanism, for QoS monitoring to be performed on the QoS flow associated to a default QoS rule.
         In some embodiments, QoS Monitoring reports may include an indication of QOS monitoring when applied on the QoS flow associated to the default QoS rule (e.g., so as to enable the consumer for determining whether fallback has taken place).
      In some embodiments, a consumer may be configured for indicating whether the provider should keep the subscription created (e.g., even if reports will not be sent), e.g., until a QoS flow is bound and dedicated to the application with QoS Monitoring enabled.
In some embodiments, an MNO may achieve significant savings in a system, e.g., in reducing signaling overhead in the QoS monitoring procedure.

In some embodiments, a system and/or method is provided which enables an NWDAF (e.g., which may be implemented for example in a core network node with NWDAF) or other consumers to handle QoS monitoring (towards app-id, meanwhile QoS enforcement is driven by PCF really) in a smooth way (e.g., without blind polls or retrials).

According to one aspect, a method in a first core network node configured to communicate with a second core network node is described. The method includes receiving, from the second core network node, a subscription request for subscribing to a Quality of Service (QOS) Monitoring event for a QoS flow bound to an application. The subscription request includes an indication to receive a QoS monitoring report on a QoS flow associated with a default QoS rule in the event no Policy Control Charging (PCC) rule is identified for the application or no PCC rule with QoS monitoring enabled is found for the application. The method also includes configuring a third core network node serving as a User Plane Function (UPF) to include in the QoS Monitoring report an indication indicating that QoS monitoring is performed on the QoS flow associated to the default QoS rule.

In some embodiments, the first core network node is configured as a Session Management Function (SMF) node.

In some other embodiments, the method further includes determining, for one or more identified PDU sessions, that there is no PCC rule with QoS monitoring enabled for the application.

In some embodiments, the method further includes, in response to the subscription request, transmitting a response to the second core network node indicating acceptance of the subscription request when there is no active PCC rule with QoS monitoring for the application.

In some embodiments, configuring the third core network node further comprises transmitting to the third core network node instructions to instruct the third core network node to add in QoS monitoring reports an indication that QoS monitoring is performed on the QoS flow associated to the default QoS rule.

According to another aspect, a first core network node configured to communicate with a second core network node is described. The first core network node being configured to receive, from the second core network node, a subscription request for subscribing to a Quality of Service (QOS) Monitoring event for a QoS flow bound to an application. The subscription request includes an indication to receive a QoS monitoring report on a QoS flow associated with a default QoS rule in the event no Policy Control Charging (PCC) rule is identified for the application or no PCC rule with QoS monitoring enabled is found for the application. The first core network node is also configured to configure a third core network node serving as a User Plane Function (UPF) to include in the QoS Monitoring report an indication indicating that QoS monitoring is performed on the QoS flow associated to the default QoS rule.

In some embodiments, the first core network node is configured as a Session Management Function (SMF) node.

In some other embodiments, the first core network node is configured to determine, for one or more identified PDU sessions, that there is no PCC rule with QoS monitoring enabled for the application.

In some embodiments, the first core network node is configured to, in response to the subscription request, transmit a response to the second core network node indicating acceptance of the subscription request when there is no active PCC rule with QoS monitoring for the application.

In some embodiments, configuring the third core network node further comprises transmitting to the third core network node instructions to instruct the third core network node to add in QoS monitoring reports an indication that QoS monitoring is performed on the QoS flow associated to the default QoS rule.

According to one aspect, a method in a second core network node configured to communicate with a first core network node is described. The method includes determining a subscription request for subscribing to a Quality of Service (QOS) monitoring event for a QoS flow bound to an application. The subscription request includes an indication indicating that the second core network node requested to receive a QoS monitoring report on a QoS flow associated to a default QoS Rule if no Policy Control Charging (PCC) Rule is identified for the application or no PCC Rule with QoS Monitoring enabled is found for the application. The method also includes transmitting, to the first core network node, the subscription request.

In some embodiments, the method further includes receiving an acceptance response from the first core network node when there is no active PCC rule with QoS monitoring for the application.

In some other embodiments, the method further includes receiving, from a third core network node serving as a User Plane Function (UPF), a QoS monitoring report including a default indication indicating that QoS monitoring is performed on the QoS flow associated to the default QoS rule.

In some embodiments, the second core network node is configured as a Network Data Analytics Function (NWDAF) node or a Unified Data Management (UDM) node, and the first core network node is a Session Management Function (SMF).

According to another aspect, a second core network node configured to communicate with a first core network node is described. The second core network node is configured to determine a subscription request for subscribing to a Quality of Service (QoS) monitoring event for a QoS flow bound to an application. The subscription request includes an indication indicating that the second core network node requested to receive a QoS monitoring report on a QoS flow associated to a default QoS Rule if no Policy Control Charging (PCC) Rule is identified for the application or no PCC Rule with QoS Monitoring enabled is found for the application. The second core network node is further configured to transmit, to the first core network node, the subscription request.

In some embodiments, the second core network node is further configured to receive an acceptance response from the first core network node when there is no active PCC rule with QoS monitoring for the application.

In some other embodiments, the second core network node is further configured to receive, from a third core network node serving as a User Plane Function (UPF), a QoS monitoring report including a default indication indicating that QoS monitoring is performed on the QoS flow associated to the default QoS rule.

According to one aspect, a computer program is described and includes instructions which, when executed on one or more processors of a core network node cause the one or more processors to carry out the method described in this section.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating an example 3GPP communication system;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a core network node (e.g., a core network node including a NWDAF for implementing NWDAF functionality) for supporting enhanced quality of service QoS monitoring according to some embodiments of the present disclosure;

FIG. 9 is a flowchart of an example process in another core network node (e.g., a core network node including a UPF and/or SMF for implementing UPF and/or SMF functionality) for supporting enhanced quality of service QoS monitoring according to some embodiments of the present disclosure;

FIG. 10 is a flowchart of an example process in a core network node according to some embodiments of the present disclosure;

FIG. 11 is a flowchart of an example process in another core network node according to some embodiments of the present disclosure;

FIG. 12 is a flowchart of an example process in a communication system according to some embodiments (e.g., Direct Subscription embodiments) of the present disclosure; and

FIG. 13 is a flowchart of another example process in a communication system according to some embodiments (e.g., Indirect Subscription embodiments) of the present disclosure.

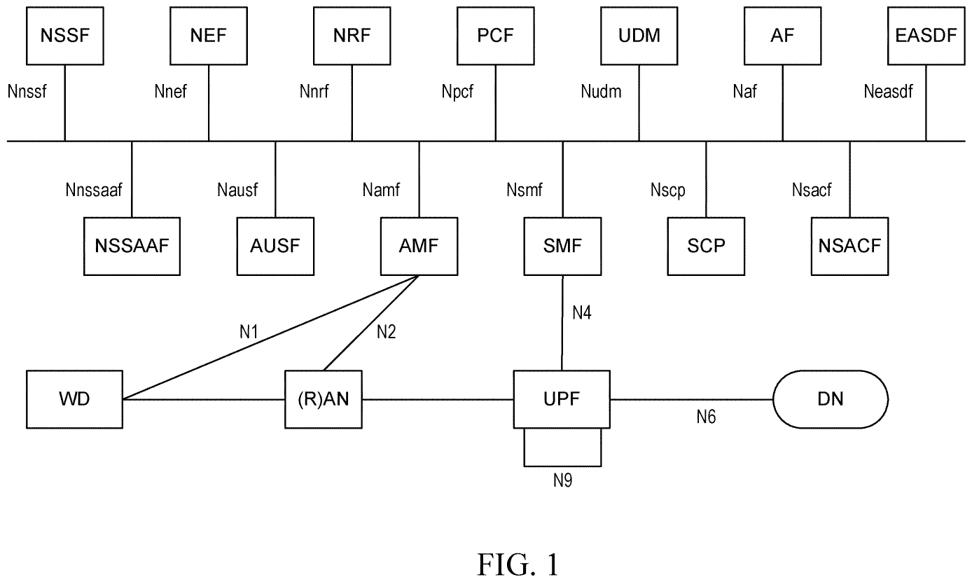

### DETAILED DESCRIPTION

Before describing in detail example embodiments, it is noted that the embodiments reside primarily in combinations of apparatus components and processing steps related to supporting enhanced quality of service QoS monitoring. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the term “core network node” is used, which can be any kind of network node, core node, virtual node, centralized unit (CU), cloud node, cloud server, host computer, etc., which provides one or more core network or other 3GPP network functions, such as PCF, AMF, etc.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

As used herein, the term “consumer” may refer to any entity, device, and/or network function which uses resources in a communication system, such as core network nodes implementing network functions in a 3GPP 5G NR system. In some embodiments herein, an NWDAF or a UDM are used as examples of consumers, but embodiments of the present disclosure are not limited to NWDAF-type or UDM-type consumers, and other types of network functions or processes or core network nodes or network nodes may be considered “consumers” as used herein.

Also as used herein, the term “provider” may refer to any entity, device, and/or network function which uses resources in a communication system, such as core network nodes implementing network functions in a 3GPP 5G NR system. In some embodiments herein, an SMF is used as examples of producer, but embodiments of the present disclosure are not limited to SMF-type consumers, and other types of network functions or processes or core network nodes or network nodes may be considered “producers” as used herein.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting enhanced quality of service QoS monitoring.

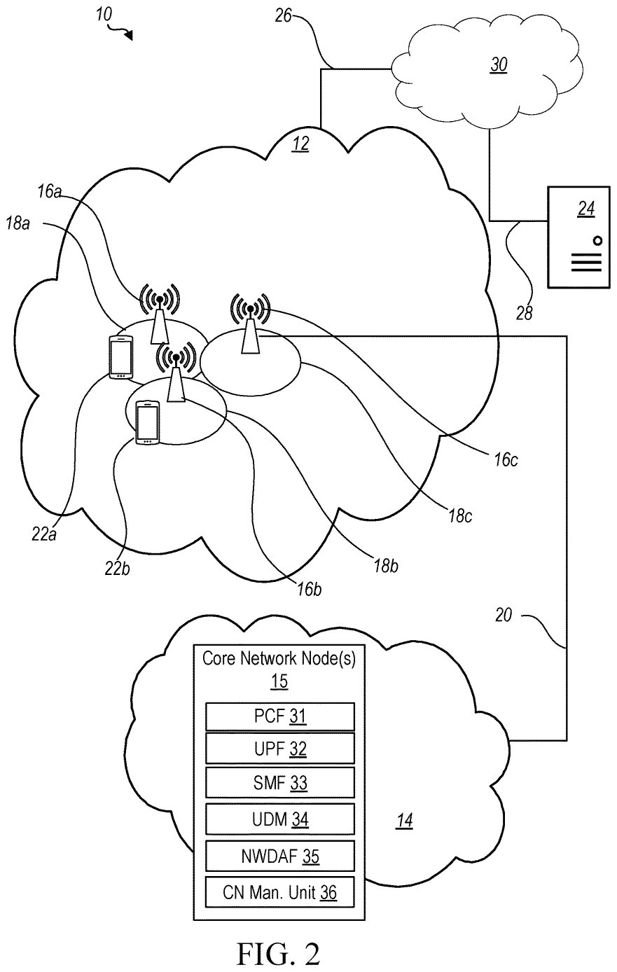

Referring now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The core network 14 comprises one or more core network nodes 15 (collectively referred to as core network node 15), which may provide one or more core network functions.

The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18).

Each network node 16a, 16b, 16c is connectable to the core network 14 (and/or core network node 15) over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only a single core network node 15, two WDs 22, and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

In some embodiments, the host computer 24 may provide one or more core network node 15 functionalities.

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A core network node 15 may be configured to include a PCF 31, which is configured for supporting enhanced quality of service QoS monitoring, as described herein. For example, in some embodiments, a core network node 15 is a PCF 31 or PCF node 31.

Core network node 15 may be configured to include a UPF 32, which is configured for supporting enhanced quality of service QoS monitoring, as described herein. For example, in some embodiments, a core network node 15 is a UPF 32 or UPF node 32.

Core network node 15 may be configured to include an SMF 33, which is configured for supporting enhanced quality of service QoS monitoring, as described herein. For example, in some embodiments, a core network node 15 is a SMF 33 or SMF node 33.

Core network node 15 may be configured to include a UDM 34, which is configured for supporting enhanced quality of service QoS monitoring, as described herein. For example, in some embodiments, a core network node 15 is a UDM 34 or UDM node 34.

Core network node 15 may be configured to include a NWDAF 35, which is configured for supporting enhanced quality of service QoS monitoring, as described herein. For example, in some embodiments, a core network node 15 is a NWDAF 35 or NWDAF node 35.

Core network node 15 may be configured to include a core network (CN) management unit 36 which is configured to perform any step and/or task and/or process and/or method and/or feature described in the present disclosure, e.g., core network node functions which may include the function of one or more of PCF 31, UPF 32, SMF 33, UDM 34, and NWDAF 35.

It is to be understood that one or more of functions (alternatively, referred to as “units”) 31-35 may reside in a single core network node 15, or may be distributed among one or more core network nodes 15, host computer(s) 24, cloud servers, data centers, etc.

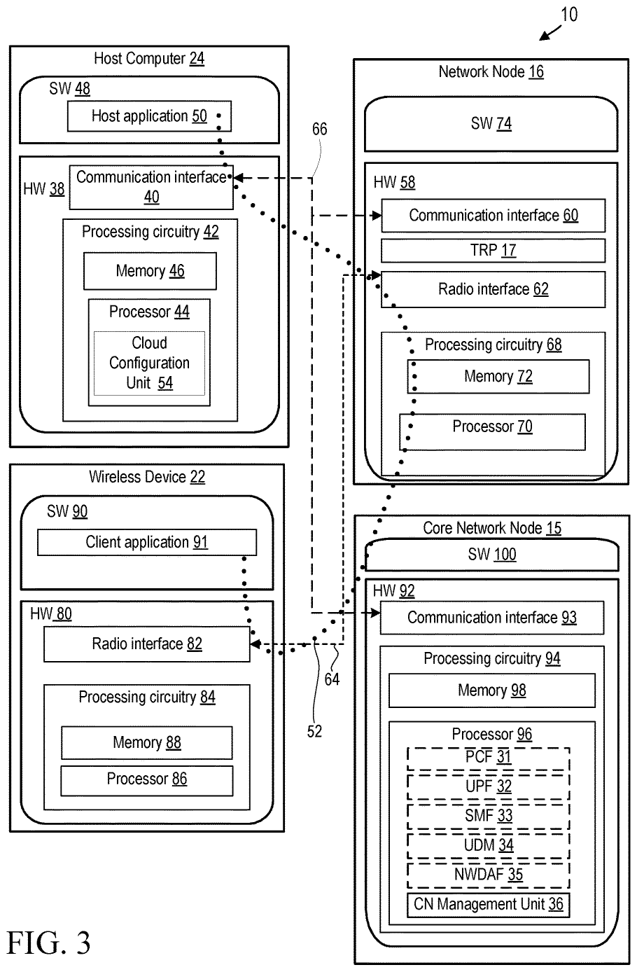

Example implementations, in accordance with an embodiment, of the WD 22, core network node 15, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the core network node 15, network node 16 and or the wireless device 22. The processing circuitry 42 of the host computer 24 may include a cloud configuration unit 54 configured to enable the service provider to observe/monitor/ control/transmit to/receive from/etc. the core network node 15, network node 16 and or the wireless device 22. For example, cloud configuration unit 54 may be configured for performing and/or supporting one or more functions of any one or more of PCF 31, UPF 32, SMF 33, UDM 34, and NWDAF 35, e.g., in the context of supporting enhanced quality of service QoS monitoring, as described herein.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24 and/or core network node(s) 15. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 91. The client application 91 may be operable to provide a service to a human or non-human user via the WD 22, with the support of the host computer 24. In the host computer 24, an executing host application 50 may communicate with the executing client application 91 via the OTT connection 52 terminating at the WD 22 and the host computer 24. In providing the service to the user, the client application 91 may receive request data from the host application 50 and provide user data in response to the request data. The OTT connection 52 may transfer both the request data and the user data. The client application 91 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 91 may include instructions that, when executed by the processor 86 and/or processing circuitry 84, causes the processor 86 and/or processing circuitry 84 to perform the processes described herein with respect to WD 22.

The communication system 10 further includes a core network node 15 provided in a communication system 10 and including hardware 92 enabling it to communicate with the host computer 24, network node 16, and with the WD 22. The hardware 92 may include a communication interface 93 for setting up and maintaining a wired or wireless connection with an interface of a different communication device of the communication system 10. The communication interface 93 may be configured to facilitate a connection 66 to the host computer 24, network nodes 16, WDs 22, and/or other core network node(s) 15. The connection 66 may be direct or it may pass through an access network 12 and/or core network 14 of the communication system 10 and/or through one or more intermediate networks 30 outside the communication system 10.

In the embodiment shown, the hardware 92 of the core network node 15 further includes processing circuitry 94. The processing circuitry 94 may include a processor 96 and a memory 98. In particular, in addition to or instead of a processor, such as a central processing unit, and memory, the processing circuitry 94 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 96 may be configured to access (e.g., write to and/or read from) the memory 98, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the core network node 15 further has software 100 stored internally in, for example, memory 98, or stored in external memory (e.g., database, storage array, network storage device, etc.) accessible by the core network node 15 via an external connection. The software 100 may be executable by the processing circuitry 94. The processing circuitry 94 may be configured to control any of the methods and/or processes described herein and/or to cause such methods, and/or processes to be performed, e.g., by core network node 15. Processor 96 corresponds to one or more processors 96 for performing core network node 15 functions described herein. The memory 98 is configured to store data, programmatic software code and/or other information described herein. In some embodiments, the software 100 may include instructions that, when executed by the processor 96 and/or processing circuitry 94, causes the processor 96 and/or processing circuitry 94 to perform the processes described herein with respect to core network node 15. Further, processor 96 may be configured to include a CN management unit 36 which is configured to perform any step and/or task and/or process and/or method and/or feature described in the present disclosure, e.g., core network node functions which may include the function of one or more of PCF 31, UPF 32, SMF 33, UDM 34, and NWDAF 35.

While core network node 15 is illustrated in FIG. 3 as including PCF 31, UPF 32, SMF 33, UDM 34, NWDAF 35, and CN management unit 36, one or more of these units and/or nodes and/or functionalities may be configured in one or more separate core network nodes 15.

In some embodiments, the inner workings of the core network node 15, network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16 and/or core network node 15.

Although FIGS. 2 and 3 show various “functions” (also referred to as “units”) such as PCF 31, UPF 32, SMF 33, UDM 34, and NWDAF 35, as being within a respective processor, it is contemplated that these units may be implemented such that a portion of the unit is stored in a corresponding memory within the processing circuitry. In other words, the units may be implemented in hardware or in a combination of hardware and software within the processing circuitry.

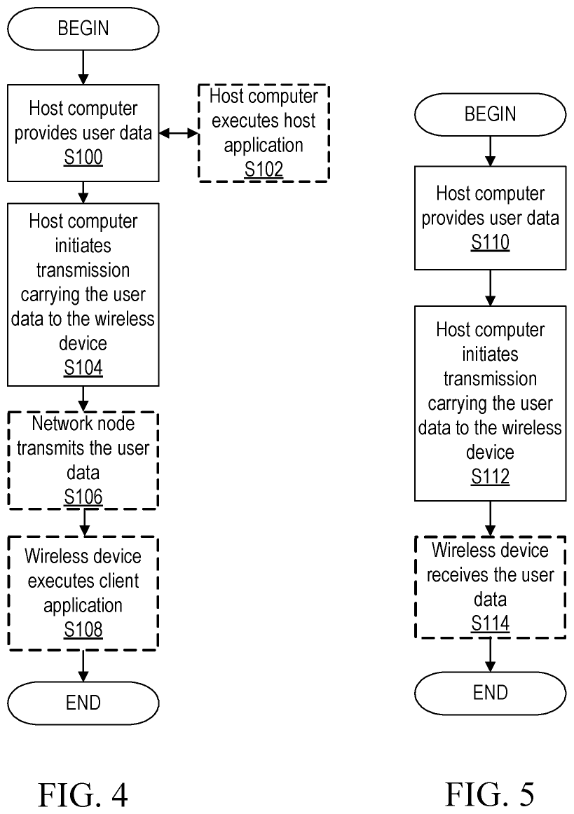

FIG. 4 is a flowchart illustrating an example method implemented in a communication system, such as, for example, the communication system of FIGS. 2 and 3, in accordance with one embodiment. The communication system may include a host computer 24, a core network node 15, network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 91, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a core network node 15, network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

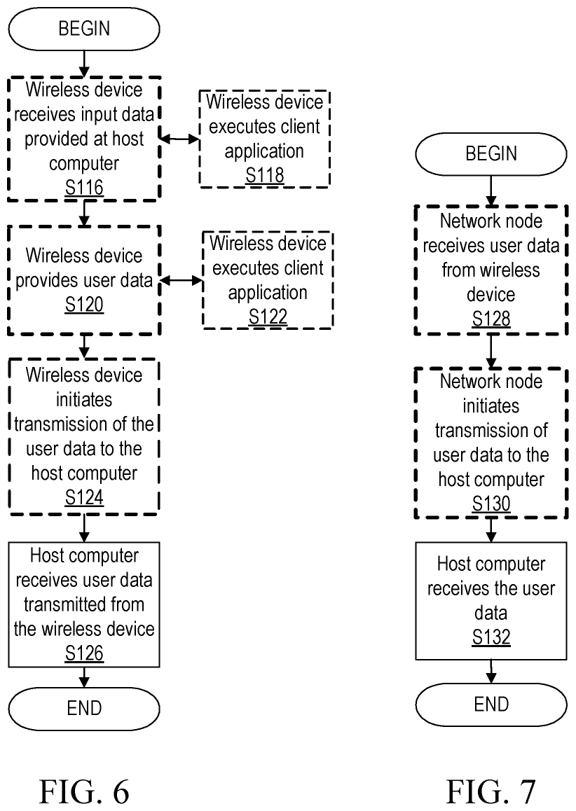

FIG. 6 is a flowchart illustrating an example method implemented in a communication system, such as, for example, the communication system of FIG. 2, in accordance with one embodiment. The communication system may include a host computer 24, a core network node 15, network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 91, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 91 (Block S122). In providing the user data, the executed client application 91 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a core network node 15, network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

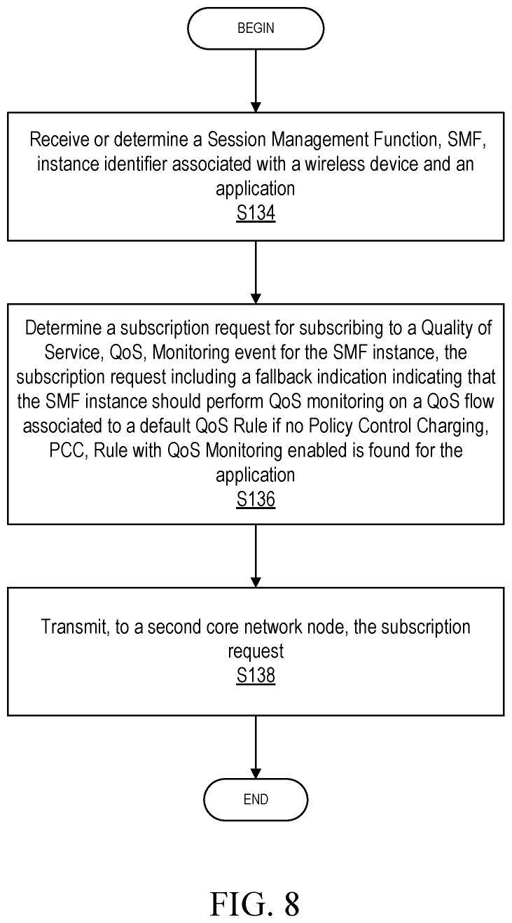

FIG. 8 is a flowchart of an example process in a first core network node 15 (e.g., a core network node including a NWDAF 35 for implementing NWDAF functionality) for supporting enhanced QoS monitoring. One or more blocks described herein may be performed by one or more elements of the first core network node 15 such as by one or more of processing circuitry 94 (including the PCF 31, UPF 32, SMF 33, UDM 34, and/or NWDAF 35), processor 96, and/or communication interface 93. The first core network node 15 is configured to receive or determine (Block S134) a Session Management Function, SMF, instance identifier associated with a wireless device 22 and an application. The first core network node 15 is configured to determine (Block S136) a subscription request for subscribing to a Quality of Service, QoS, Monitoring event for the SMF instance, where the subscription request includes a fallback indication indicating that the SMF instance should perform QoS monitoring on a QoS flow associated to a default QoS Rule if no Policy Control Charging, PCC, Rule with QoS Monitoring enabled is found for the application. The first core network node 15 is configured to transmit (Block S138) to a second core network node 15 the subscription request.

In some embodiments, the first core network node 15 is further configured to receive a QoS Monitoring report from a third core network node 15 (e.g., serving as an Up Packet Forwarding, UPF, function node), where the report including a default indication indicates that QoS monitoring is performed on the QoS flow associated to the default QoS Rule.

In some embodiments, the first core network node 15 serves as a Network Data Analytics Function, NWDAF, node. In some embodiments, the second core network node 15 may serve as a Session Management Function, SMF, node. In some embodiments, the third core network node 15 may serve as a UPF node. In some embodiments, the first, second, and/or third core network nodes 15 may be implemented in the same node, device, server, etc., or in two or more different and/or distributed nodes, devices, servers, etc.

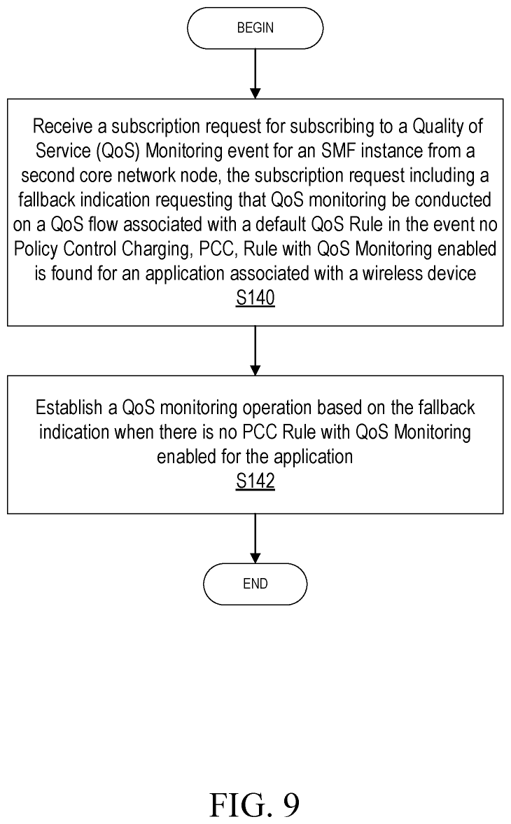

FIG. 9 is a flowchart of an example process in a first core network node 15 node (e.g., a core network node including SMF 33 for implementing SMF functionality) for supporting enhanced QoS monitoring. One or more blocks described herein may be performed by one or more elements of the first core network node 15 such as by one or more of processing circuitry 94 (including the PCF 31, UPF 32, SMF 33, UDM 34, and/or NWDAF 35), processor 96, and/or communication interface 93. The first core network node 15 is configured to receive (Block S140) a subscription request for subscribing to a Quality of Service (QOS) Monitoring event for an SMF instance from a second core network node 15, where the subscription request includes a fallback indication requesting that QoS monitoring be conducted on a QoS flow associated with a default QoS Rule in the event no Policy Control Charging, PCC, Rule with QoS Monitoring enabled is found for an application associated with a wireless device 22. The first core network node 15 is configured to establish (Block S142) a QoS monitoring operation based on the fallback indication when there is no PCC Rule with QoS Monitoring enabled for the application.

In some embodiments, the second core network node 15 may serve as a Session Management Function, SMF, node.

In some embodiments, the first core network node 15 is further configured to transmit an acceptance response to the first core network node 15 when there is no active PCC Rule with QoS Monitoring for the application.

In some embodiments, the first core network node 15 is further configured to perform Quality of Service (QOS) Monitoring based on the fallback indication on the QoS flow associated to the default QoS Rule and configure a third core network node 15 serving as an Up Packet Forwarding, UPF, function to include a default indication in a QoS Monitoring report, the default indication indicating that QoS monitoring is performed on the QoS flow associated to the default QoS Rule.

In some embodiments, the first core network node 15 serves as a Network Data Analytics Function, NWDAF, node. In some embodiments, the second core network node 15 may serve as a Session Management Function, SMF, node. In some embodiments, the third core network node 15 may serve as a UPF node. In some embodiments, the first, second, and/or third core network nodes 15 may be implemented in the same node, device, server, etc., or in two or more different and/or distributed nodes, devices, servers, etc.

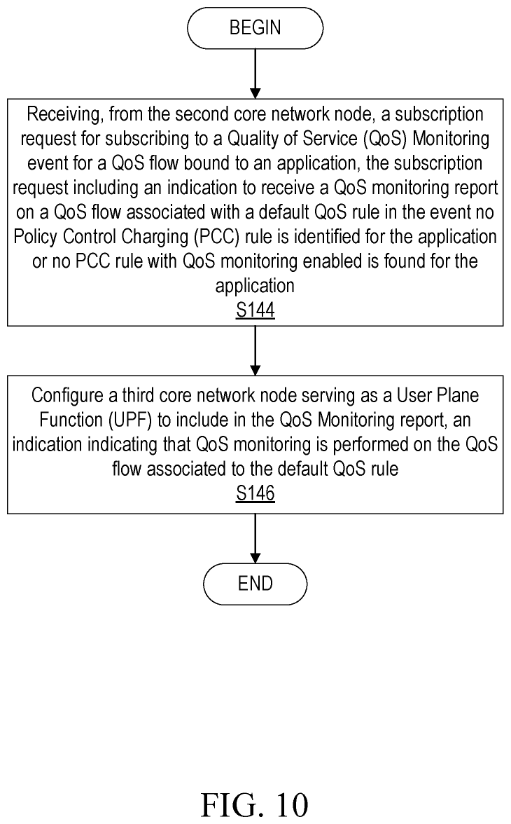

FIG. 10 is a flowchart of an example process in a first core network node 15 node (e.g., a core network node including SMF 33 for implementing SMF functionality) for supporting enhanced QoS monitoring. One or more blocks described herein may be performed by one or more elements of the first core network node 15 such as by one or more of processing circuitry 94 (including SMF 33 and/or CN management unit 36, etc.), processor 96, and/or communication interface 93, etc. The first core network node 15 is configured to receive (Block S144), from the second core network node 15, a subscription request for subscribing to a Quality of Service (QOS) Monitoring event for a QoS flow bound to an application. The subscription request includes an indication to receive a QoS monitoring report on a QoS flow associated with a default QoS rule in the event no Policy Control Charging (PCC) rule is identified for the application or no PCC rule with QoS monitoring enabled is found for the application. The first core network node 15 is further configured to configure (Block S146) a third core network node 15 serving as a User Plane Function (UPF) 32 to include in the QoS Monitoring report an indication indicating that QoS monitoring is performed on the QoS flow associated to the default QoS rule.

In some embodiments, the first core network node is configured as a Session Management Function (SMF) 33 node.

In some other embodiments, the method further includes determining, for one or more identified PDU sessions, that there is no PCC rule with QoS monitoring enabled for the application.

In some embodiments, the method further includes, in response to the subscription request, transmitting a response to the second core network node indicating acceptance of the subscription request when there is no active PCC rule with QoS monitoring for the application.

In some embodiments, configuring the third core network node 15 further comprises transmitting to the third core network node 15 instructions to instruct the third core network node 15 to add in QoS monitoring reports an indication that QoS monitoring is performed on the QoS flow associated to the default QoS rule.

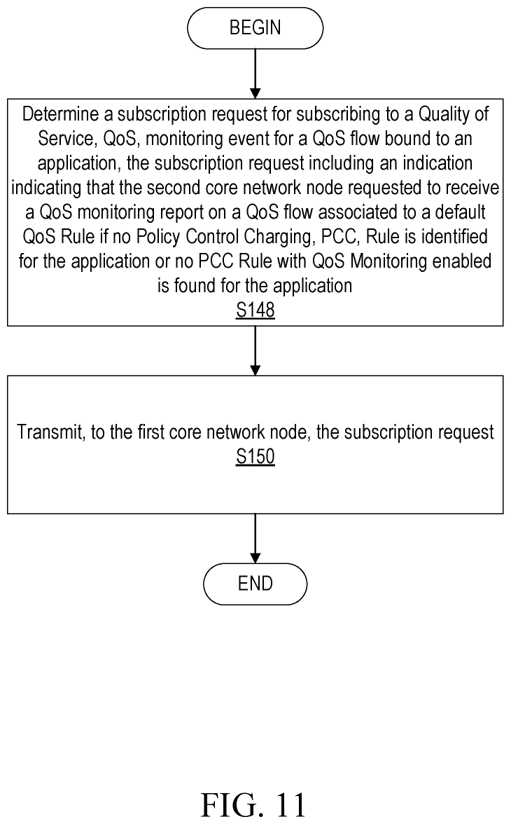

FIG. 11 is a flowchart of an example process in a second core network node 15 (e.g., a core network node including a NWDAF 35 for implementing NWDAF functionality or a UDM 34 for implementing a UDM functionality) for supporting enhanced QoS monitoring. One or more blocks described herein may be performed by one or more elements of the second core network node 15 such as by one or more of processing circuitry 94 (including UDM 34, and/or NWDAF 35 and/or CN management unit 36, etc.), processor 96, and/or communication interface 93, etc. The second core network node 15 is configured to determine (Block S148) a subscription request for subscribing to a Quality of Service (QOS) monitoring event for a QoS flow bound to an application. The subscription request includes an indication indicating that the second core network node 15 requested to receive a QoS monitoring report on a QoS flow associated to a default QoS Rule if no Policy Control Charging (PCC) Rule is identified for the application or no PCC Rule with QoS Monitoring enabled is found for the application. The second core network node 15 is configured to transmit (Block S150), to the first core network node 15, the subscription request.

In some embodiments, the method further includes receiving an acceptance response from the first core network node 15 when there is no active PCC rule with QoS monitoring for the application.

In some other embodiments, the method further includes receiving, from a third core network node 15 serving as a User Plane Function (UPF) 32, a QoS monitoring report including a default indication indicating that QoS monitoring is performed on the QoS flow associated to the default QoS rule.

In some embodiments, the second core network node is configured as a Network Data Analytics Function (NWDAF) 35 node or a Unified Data Management (UDM) 34 node, and the first core network node is a Session Management Function (SMF) 33.

Having described the general process flow of arrangements of the disclosure and having provided examples of hardware and software arrangements for implementing the processes and functions of the disclosure, the sections below provide details and examples of arrangements for supporting enhanced QoS monitoring. In one or more embodiments, the term UE is used and may refer to WD 22. For example, UE identifier (UE-ID) may refer to a WD 22 identifier.

In one or more embodiments, the term “indication” is used and may refer to information, data, signaling, resources, one or more bits, etc. which may be used to indicate a state, a request, or any other information. Examples of indications may include, without being limited to, instructions such as fall back instructions (or FallBackInstructions), a default indication (or DefaultIndication), etc.

In one or more embodiments, default indication may refer to an indication of an action such as an action that is being enforced and/or a monitoring that is performed.

In some embodiments, the term fallback indication (or fallback instruction) is used and may refer to an indication and/or request requesting that QoS monitoring be conducted on a QoS flow. The QoS flow may be associated with a default QoS rule, e.g., in the event no Policy Control Charging (PCC) rule with QoS monitoring enabled is found for an application associated with a WD 22.

In some embodiments, the term default value is used and may refer to a default QOS rule or any other default value. In one or more embodiments, the default QoS rule refers to any value as described in the following section.

### QoS Parameters—Default Values

For each PDU Session Setup, the SMF 33 retrieves the subscribed Session-AMBR (Aggregate Maximum Bit Rate) values as well as the subscribed default values for the 5G QoS Identifier (5QI) and the Allocation and Retention Priority (ARP) and optionally, the 5QI Priority Level, from the UDM 34. The subscribed default 5QI value may be a Non-GBR 5QI from the standardized value range.

The 5QI Priority Level can be added to the subscription information to achieve an overwriting of the standardized or preconfigured 5QI Priority Level e.g. in scenarios where dynamic PCC is not deployed, or the PCF is unavailable or unreachable.

The SMF may change the subscribed values for the default 5QI and the ARP and if received, the 5QI Priority Level, based on interaction with the PCF or, if dynamic PCC is not deployed, based on local configuration, to set QoS parameters for the QoS Flow associated with the default QoS rule.

For QoS Flow(s) of the PDU Session other than the QoS Flow associated with the default QoS rule, the SMF may set the ARP priority level, the ARP pre-emption capability and the ARP pre-emption vulnerability to the respective values in the PCC rule(s) bound to that QoS Flow. If dynamic PCC is not deployed, the SMF may set the ARP priority level, the ARP pre-emption capability and the ARP pre-emption vulnerability based on local configuration.

The local configuration in the SMF 33 can, e.g., make use of the subscribed value for the ARP priority level and apply locally configured values for the ARP pre-emption capability and ARP pre-emption vulnerability.

If dynamic PCC is not deployed, the SMF can have a data network name (DNN) based configuration to enable the establishment of a Guaranteed Bit Rate (GBR) QoS Flow as the QoS Flow that is associated with the default QoS rule. This configuration contains a standardized GBR 5QI as well as Guaranteed Flow Bit Rate (GFBR) and Maximum Flow Bit Rate (MFBR) for uplink (UL) and downlink (DL).

Interworking with Enhanced Packet System (EPS) is not possible for a PDU Session with a GBR QOS Flow as the QoS Flow that is associated with the default QoS rule.

The SMF may change the subscribed Session-AMBR values (for UL and/or DL), based on interaction with the PCF or, if dynamic PCC is not deployed, based on local configuration, to set the Session-AMBR values for the PDU Session.

### Exposure of Events From UPF for UPF Data Collection

In some embodiments, a subscription to QoS monitoring event can target the QoS flows bound to an application by including an Application Identifier. In this case, at subscription request and/or when the PCC rules change, an SMF 33 may identify the active PCC Rule that includes a DataCollection_ApplicationIdentifier matching that Application Identifier. SMF 33 enables this consumer (e.g. NWDAF) to receive the QoS Monitoring reports enabled by that PCC Rule. The consumer may indicate that it can receive QoS Flow Performance information for the QoS Flow associated with the default QoS rule if there are no measurements available for the Application Identifier (that is, if no PCC rule is identified). In this case, the SMF 33 may instruct the UPF to perform QoS monitoring for the QoS Flow associated with the default QoS rule and include the Indication of QoS Flow associated with the default QoS Rule. The UPF 32 may then include the Indication of QoS Flow associated with the default QoS Rule in the Nupf_EventExposure_Notify service operation when sending reports. Otherwise, the SMF 33 may accept the request and indicate in the response that reporting may be activated when the measurements are enabled by a PCC rule or the SMF 33 may reject the subscription request for that Application Identifier.

One or more embodiments provide direct/indirect subscription to a provider such as core network node 15 configured as or serving as an SMF 33.

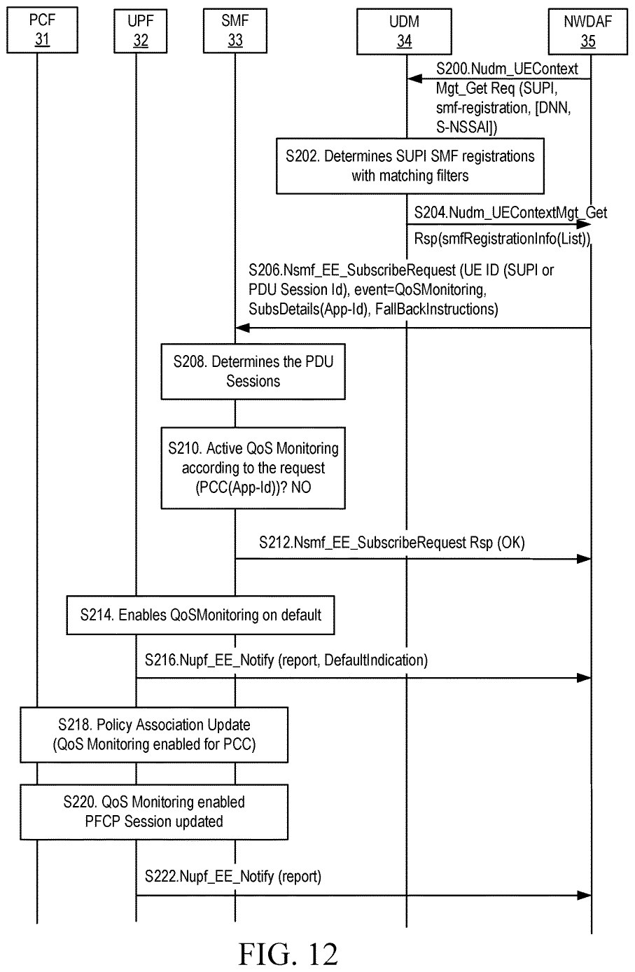

FIG. 12 is an example sequence diagram illustrating an example embodiment for the direct subscription to SMF 33 when the QoS Monitoring event consumer is the NWDAF 35. Example steps are detailed below:

Step S200) NWDAF 35, before subscribing to a QoS Monitoring event, is configured to request from the UDM 34 a list of SMF 33 instances which serve the target WD 22's PDU session(s). To do this, NWDAF 35 may be configured to send a request message (e.g., Nudm_UEContextMgt_Get Request message) to UDM 34 including the following parameters:
UE-ID (SUPI) (i.e., a WD 22 identifier).
smf-registration (to request for SMF registration for the UE-ID).

Optional: Data Network Name (DNN), Serving Network Slice Selection Assistance Information (S-NSSAI).

Step S202) UDM 34 determines the SMF registrations for UE-ID (SUPI) with the above matching filters (e.g., DNN, S-NSSAI).

Step S204) UDM 34 transmits a response message in response to the message in step S200 including the list of SMF instances registered (smfRegistrationInfo(List)) for UE-ID (SUPI).

In some embodiments, the NWDAF 35 may be configured for targeting a group of users (e.g., WDs 22), and UDM 34 may be configured to return the list of SMF instances for all WD identifiers (e.g., UE-IDs) in the group.

Step S206) Based on the list of SMF instances retrieved in Step S204 above, NWDAF 35 may be configured to subscribe to QoS Monitoring event(s) by triggering a message (e.g., subscription request message, Nsmf_EE_Subscribe Request message, etc.) including one or more of the following parameters:
WD identifier (e.g., UE-ID, SUPI or PDU Session Id).
event=QoSMonitoring.
SubsDetails(App-Id) as subscription details, in this case, e.g., the NWDAF 35 may request to monitor the QoS for a certain application (App-Id).
FallBackInstructions. This may correspond to an indication that, when present, instructs an SMF 33 about fallback, e.g., if no PCC Rule is found for the application identifier (e.g., App-Id) with QoS Monitoring enabled. In this example procedure, the fallback corresponds to performing the QoS monitoring on the QoS flow associated to the default QoS Rule.

Step S208) SMF 33 is configured to identify the targeted PDU Sessions.

Step S210) For the above PDU sessions, the SMF 33 is configured to check if QoS Monitoring is enabled according to the request (i.e., for the PCC rule of the target App-Id). In this example sequence diagram, the SMF 33 determines that there is no active QoS Monitoring policy in a PCC Rule (if any) for the application identifier (e.g., App-Id).

Step S212) Based on the FallBackInstructions received in Step S206 above, SMF 33 transmits a response message in response to the request message in Step S206 with a successful response (accepting the request). This may as an alternative to procedures where, e.g., an SMF 33 rejects the request when there is no active PCC rule with QoS Monitoring policy for the application identifier (e.g., App-Id).

Step S214) Based on the FallBackInstructions received in Step S206 above, the SMF 33 may enable QoS Monitoring on the QoS flow associated to the default QoS rule.

In some embodiments, the NWDAF 35 may be configured to instruct the SMF 33 to keep the subscription created (e.g., even if reports will not be sent) until a QoS flow is bound and dedicated to the application with QoS Monitoring enabled. In this case, the SMF 33 may be configured to create the subscription, and the procedure continues from Step S218.

In the instructions to the UPF 32, the SMF 33 may be configured to provide information informing that the UPF 32 (e.g., transparently) needs to add to the reports (e.g., “DefaultIndication”) to indicate the fallback action is being enforced and QoS monitoring is performed on the QoS flow associated to the default QoS rule.

Step S216) UPF 32 reports QoS monitoring towards the consumer (e.g., the NWDAF 35) by triggering a notification message (e.g., Nupf_EE_Notify message) including one or more of the following information:
A QOS Monitoring report; and/or
A DefaultIndication, which indicates this report refers to the QoS flow associated to the default QoS rule.

Steps S218 and S220) There may be a Policy Association Update where QoS Monitoring is enabled for the PCC rule for the application identifier (e.g., App-Id), such as where the PFCP session may be updated accordingly. The SMF 33 may not need to provide information for the UPF 32 to include in the report.

Step S222) The UPF 32 may be configured to report QoS monitoring towards the consumer (e.g., NWDAF 35), such as by triggering a notification message (e.g., a Nupf_EE_Notify message) including the following information:
A QOS Monitoring report.

In this report, the DefaultIndication (which may have been included in the previous report at step S216) is not included, which may correspond to this report referring to the QoS flow for the application identifier (e.g., App-Id), and not to the QoS flow associated to the default QoS rule.

### Indirect Subscription

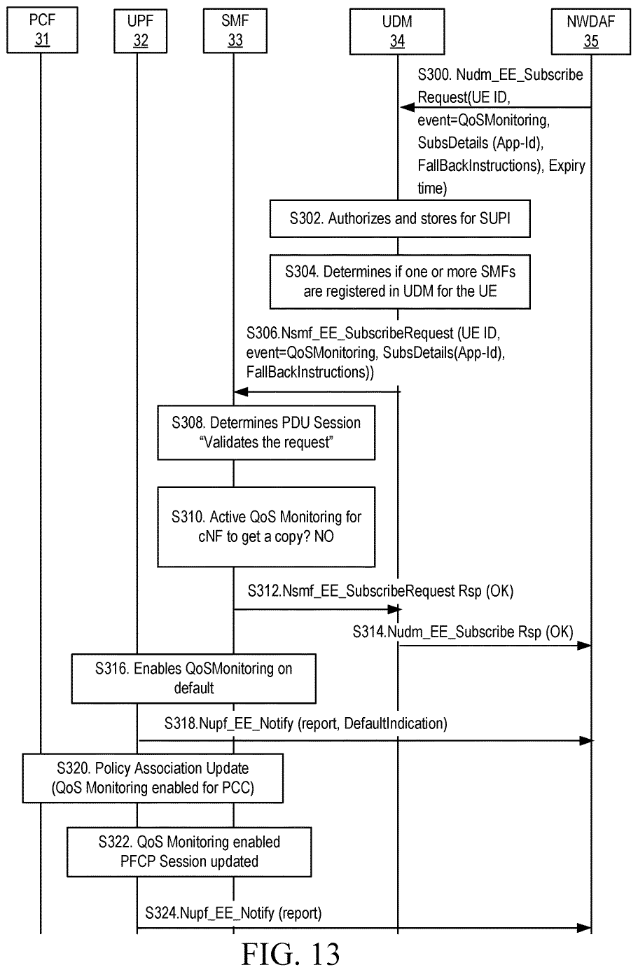

FIG. 13 is a sequence diagram illustrating another example embodiment for an indirect subscription to an SMF 33 via a UDM 34, when the QoS Monitoring event consumer is the NWDAF 35, for example. The steps are detailed below:

Step S300) A Consumer (e.g., an NWDAF 35) subscribes to a QoS Monitoring event (e.g., indirectly via UDM 34) by triggering a request message (e.g., Nudm_EE_Subscribe Request message) including one or more of the following parameters:
WD identifier (e.g., UE-ID, SUPI, etc.).
event=QoSMonitoring.
SubsDetails(App-Id) as subscription details, in this case, the NWDAF 35 may be configured to request monitoring of the QoS for a certain application (e.g., having a corresponding App-Id).
FallBackInstructions. This may correspond to an indication that, when present, instructs the SMF 33 to fall back to performing QoS monitoring on the QoS flow associated to the default QoS Rule (e.g. if no PCC Rule or, it no PCC Rule with QoS Monitoring is enabled).
Expiry time.

Step S302) The UDM 34 may be configured to authorize a subscription and stores it for the requested WD identifier (e.g., UE-ID, SUPI, etc.).

Step S304) The UDM 34 may be configured to determine if one or more SMF 33 instances are registered in the UDM 34 for the WD identifier (e.g., UE-ID, SUPI, etc.).

Step S306) For each SMF instance in Step S304 above, the UDM 34 may be configured to send the subscription to QoS Monitoring event on behalf of the NWDAF 35 by triggering a request message (e.g., subscription request message, Nsmf_EE_Subscribe Request message, etc.) including one or more of the following parameters:
WD identifier (e.g., UE-ID, SUPI, etc.)
event=QoSMonitoring.
SubsDetails(App-Id) as subscription details, in this case, the NWDAF 35 may be configured to request monitoring of the QoS for a certain application (e.g., corresponding to an App-Id).
FallBackInstructions. This may correspond to an indication that, when present, instructs the SMF 33 to fall back to performing QoS monitoring on the QoS flow associated to the default QoS rule. In case the consumer (e.g., the NWDAF 35) did not provide FallBackInstructions in the message in Step S300 above, the UDM 34 may optionally be configured (e.g., locally configured) to add them.

Step S308) the SMF 33 may be configured to determine the PDU Sessions for the WD identifier (e.g., UE-ID, SUPI, etc.).

Step S310) For the above PDU session(s), the SMF 33 may be configured to check if QoS Monitoring is enabled according to the request (i.e., there is a QoS monitoring policy for the PCC rule of the target App-Id). In this example sequence diagram, the SMF 33 may be configured to verify that there is no PCC rule for the application identifier (e.g., App-Id) or no QoS Monitoring policy for the QoS Flow bound to the PCC rule for the application identifier (e.g., App-Id).

Step S312) Based on the FallBackInstructions received in Step 4 above, the SMF 33 may be configured to answer the request message in Step S306 with a successful response (e.g., accepting the request). This may be as an alternative to a procedure where the SMF 33 may be configured to reject the request (as there is no active QoS Monitoring for App-Id).

Step S314) The UDM 34 may be configured to answer the request message in Step 1 with a successful response (accepting the request).

Step S316) Based on the FallBackInstructions received in Step S306 above, the SMF 33 may be configured to enable QoS Monitoring on the QoS flow associated to the default QoS rule.

In some embodiments, the NWDAF 35 may be configured to instruct the SMF 33 to keep the subscription created (e.g., even if reports will not be sent) until a QoS flow is bound and dedicated to the application with QoS Monitoring enabled. In this case, the SMF 33 may be configured to create the subscription, and the procedure continues from Step S320.

In the instructions to the UPF 32, the SMF 33 may be configured to provide information to the UPF 32, e.g., so it can add to the reports (e.g., “DefaultIndication”) to indicate the fallback action is being enforced and QoS monitoring is performed on the QoS flow associated to the default QoS rule.

Step S318) The UPF 32 may be configured to report QoS monitoring towards the consumer (e.g., the NWDAF 35) by triggering a Nupf_EE_Notify message including the following information:
QoS Monitoring report; and/or
DefaultIndication, which may indicate that this report refers to the default QOS flow.

Steps S320 and S322) There may be a Policy Association Update where QoS Monitoring is enabled for the PCC rule for App-Id including a QoS monitoring policy, so the PFCP session may be updated accordingly. In some embodiments, the SMF 33 may not need to provide information for UPF 32 to include in the report.

Step S324) The UPF 32 may be configured to report QoS monitoring towards the consumer (e.g., the NWDAF 35) by triggering a Nupf_EE_Notify message including the following information:
QoS Monitoring report.

In this report, the DefaultIndication (which may have been included in the previous report at step S318) is not included, which means this report refers to the QoS flow for the application identifier (e.g., App-Id), and not to the default QoS flow.

Embodiments of the present disclosure may, as an example, be described in 3GPP TS 23.502 V18.5.0 according to:
Consumer (e.g., NWDAF 35) including in the subscription to QoS Monitoring event for a certain application an indication to allow using as fall back mechanism the QoS monitoring for the default QoS flow.
QoS Monitoring reports including an indication of QoS monitoring when applied for the default QoS flow (as an alternative to QoS monitoring when applied for the PCC rule for that application).

The following is a nonlimiting list of example embodiments.
1. A first core network node, the first core network node comprising processing circuitry configured to:
receive or determine a Session Management Function, SMF, instance identifier associated with a wireless device and an application;
determine a subscription request for subscribing to a Quality of Service, QoS, Monitoring event for the SMF instance, the subscription request including a fallback indication indicating that the SMF instance should perform QoS monitoring on a QoS flow associated to a default QoS Rule if no Policy Control Charging, PCC, Rule with QoS Monitoring enabled is found for the application; and
cause transmission, to a second core network node, of the subscription request.
2. The first core network node of Example 1, wherein the first core network node serves as a Network Data Analytics Function, NWDAF, node.

3. The first core network node of any one of Examples 1 and 2, wherein the processing circuitry is further configured to:
receive a QoS Monitoring report from a third core network node serving as an Up Packet Forwarding, UPF, function, wherein the report includes a default indication indicating that QoS monitoring is performed on the QoS flow associated to the default QoS Rule.
4. A method implemented in a first core network node, the method comprising:
receiving or determining a Session Management Function, SMF, instance identifier associated with a wireless device and an application;
determining a subscription request for subscribing to a Quality of Service, QoS, Monitoring event for the SMF instance, the subscription request including a fallback indication indicating that the SMF instance should perform QoS monitoring on a QoS flow associated to a default QoS Rule if no Policy Control Charging, PCC, Rule with QoS Monitoring enabled is found for the application; and
transmitting, to a second core network node, the subscription request.
5. The method of Example 4, wherein the first core network node serves as a Network Data Analytics Function, NWDAF, node.
6. The method of any one of Examples 4 and 5, wherein the method further comprises:
receiving a QoS Monitoring report from a third core network node serving as an Up Packet Forwarding, UPF, function, wherein the report includes a default indication indicating that QoS monitoring is performed on the QoS flow associated to the default QOS Rule.
7. A first core network node comprising processing circuitry configured to:
receive a subscription request for subscribing to a Quality of Service (QOS) Monitoring event for a Session Management Function, SMF, instance from a second core network node, the subscription request including a fallback indication requesting that QoS monitoring be conducted on a QoS flow associated with a default QoS Rule in the event no Policy Control Charging, PCC, Rule with QoS Monitoring enabled is found for an application associated with a wireless device; and
establish a QoS monitoring operation based on the fallback indication when there is no PCC Rule with QoS Monitoring enabled for the application.
8. The first core network node of Example 7, wherein the first core network node serves as a Session Management Function, SMF, node.
9. The first core network node of any one of Examples 7 and 8, wherein processing circuitry is further configured to:
cause transmission of an acceptance response to the first core network node when there is no active PCC Rule with QoS Monitoring for the application.
10. The first core network node of any one of Examples 7-9, wherein the processing circuitry is further configured to:
perform Quality of Service (QOS) Monitoring based on the fallback indication on the QoS flow associated to the default QoS Rule; and
configure a third core network node serving as an Up Packet Forwarding, UPF, function to include a default indication in a QoS Monitoring report, the default indication indicating that QoS monitoring is performed on the QoS flow associated to the default QoS Rule.
11. The first core network node of any one of Examples 7-10, wherein the processing circuitry is further configured to:
upon receiving a Policy Association Update enabling QoS Monitoring for the PCC rule for the application, update the QoS monitoring to refer to the QoS flow for the application and not to the QoS flow associated with the default QoS Rule.
12. A method implemented in a first core network node, the method comprising:
receiving a subscription request for subscribing to a Quality of Service (QOS) Monitoring event for a Session Management Function, SMF, instance from a second core network node, the subscription request including a fallback indication requesting that QoS monitoring be conducted on a QoS flow associated with a default QoS Rule in the event no Policy Control Charging, PCC, Rule with QoS Monitoring enabled is found for an application associated with a wireless device; and
establishing a QoS monitoring operation based on the fallback indication when there is no PCC Rule with QoS Monitoring enabled for the application.
13. The method of Example 12, wherein the first core network node serves as a Session Management Function, SMF, node.
14. The method of any one of Claims 12 and 13, wherein the method further comprises:
transmitting an acceptance response to the first core network node when there is no active PCC Rule with QoS Monitoring for the application.
15. The method of any one of Examples 12-14, wherein the method further comprises:
performing Quality of Service (QOS) Monitoring based on the fallback indication on the QoS flow associated to the default QoS Rule; and
configuring a third core network node serving as an Up Packet Forwarding, UPF, function to include a default indication in a QoS Monitoring report, the default indication indicating that QoS monitoring is performed on the QoS flow associated to the default QoS Rule.
16. The method of any one of Examples 12-15, wherein the processing circuitry is further configured to:
upon receiving a Policy Association Update enabling QoS Monitoring for the PCC rule for the application, updating the QoS monitoring to refer to the QoS flow for the application and not to the QoS flow associated with the default QoS Rule.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AF Application Function
AMF Access and Mobility Function
API Application Programming Interface
MNO Mobile Network Operator
NEF Network Exposure Function
PCF Policy Control Function
PFCP Packet Flow Control Protocol
QoS Quality of Service
RAN Radio Access Network
SMF Session Management Function
S-NSSAI Serving Network Slice Selection Assistance Information
SUPI Subscription Permanent Identifier
UDM User Data Management
UDR User Data Repository
UE User Equipment
UPF User Plane Function

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-13. (canceled)

14. A method in a session management entity, the method comprising:
receiving, from a second core network node, a subscription request to a Quality of Service (QOS) Monitoring event for a QoS flow bound to an application, the subscription request including an indication to receive a QoS monitoring report on a QoS flow bound to an application and associated with a default QoS rule;
in response to the subscription request, sending to a user plane function a request for QoS monitoring for the QOS Flow associated with the default QoS rule when no Policy Control Charging (PCC) rule is identified for the application or no PCC rule with QoS monitoring enabled is found for the application, the request including an indication that the QOS Flow is associated with the default QoS Rule; and
the indication is to be provided to the second network node in direct event notification when reporting by the user plane function the QoS monitoring event to the second network node.

15. The method of claim 14, wherein the second core network node is as a Network Data Analytics function (NWDAF) or a User Data management (UDM) entity.

16. The method of claim 15, wherein the method further includes:
determining, for one or more identified PDU sessions, that there is no PCC rule with QoS monitoring enabled for the application.

17. The method of claim 15, wherein the method further includes:
in response to the subscription request, transmitting a response to the second core network node indicating acceptance of the subscription request when there is no active PCC rule with QoS monitoring for the application.

18. The method of claim 14, wherein the method further includes:
determining, for one or more identified PDU sessions, that there is no PCC rule with QoS monitoring enabled for the application.

19. The method of claim 14, wherein the method further includes:
in response to the subscription request, transmitting a response to the second core network node indicating acceptance of the subscription request when there is no active PCC rule with QoS monitoring for the application.

20. A core network node comprising:
processing circuitry, the processing circuitry configured to:
receive, from a second core network node, a subscription request to a Quality of Service (QOS) Monitoring event for a QoS flow bound to an application, the subscription request including an indication to receive a QoS monitoring report on a QOS flow bound to an application and associated with a default QoS rule;
in response to the subscription request, cause sending to a user plane function of a request for QOS monitoring for the QOS Flow associated with the default QoS rule when no Policy Control Charging (PCC) rule is identified for the application or no PCC rule with QoS monitoring enabled is found for the application, the request including an indication that the QoS Flow is associated with the default QOS Rule; and
the indication is to be provided to the second network node in direct event notification when reporting by the user plane function the QoS monitoring event to the second network node.

21. The core network node of claim 20, wherein the second core network node is as a Network Data Analytics function (NWDAF) or a User Data management (UDM) entity.

22. The core network node of claim 21, wherein the processing circuitry is further configured to:
determine, for one or more identified PDU sessions, that there is no PCC rule with QoS monitoring enabled for the application.

23. The core network node of claim 20, wherein the processing circuitry is further configured to:
determine, for one or more identified PDU sessions, that there is no PCC rule with QoS monitoring enabled for the application.

24. The core network node of claim 20, wherein the processing circuitry is further configured to:
in response to the subscription request, cause transmission of a response to the second core network node indicating acceptance of the subscription request when there is no active PCC rule with QOS monitoring for the application.

25. A method in a user plane entity, the method comprising:
receiving from a session management entity a request for Quality of Service (QOS) monitoring for a QOS Flow bound to an application and the QoS flow is associated with a default QOS rule, the request including an indication that the QOS Flow is associated with the default QOS Rule; and
sending to a second network node a direct event notification comprising QoS monitoring report for the QOS flow and the indication that the QoS Flow is associated with the default QoS Rule.

26. The method of claim 25, wherein the indication is received from the session management entity when no Policy Control Charging, (PCC) rule is identified for the application or no PCC rule with QoS monitoring enabled is found for the application.

27. The method of claim 26, wherein the second core network node is configured as a Network Data Analytics Function (NWDAF) node or a Unified Data Management (UDM).

28. The method of claim 25, wherein the second core network node is configured as a Network Data Analytics Function (NWDAF) node or a Unified Data Management (UDM).

29. A core network node comprising:
processing circuitry, the processing circuitry configured to:
receive from a session management entity a request for Quality of Service (QOS) monitoring for a QOS Flow bound to an application and the QoS flow is associated with a default QOS rule, the request including an indication that the QOS Flow is associated with the default QOS Rule; and
cause sending to a second network node of a direct event notification comprising QoS monitoring report for the QoS flow and the indication that the QoS Flow is associated with the default QOS Rule.

30. The core network node of claim 29, wherein the indication is received from the session management entity when no Policy Control Charging, (PCC) rule is identified for the application or no PCC rule with QoS monitoring enabled is found for the application.

31. The core network node of claim 30, wherein the second core network node is configured as a Network Data Analytics Function (NWDAF) node or a Unified Data Management (UDM).

32. The core network node of claim 29, wherein the second core network node is configured as a Network Data Analytics Function (NWDAF) node or a Unified Data Management (UDM).

33. A computer storage medium storing a computer program, comprising instructions which, when executed on one or more processors of a network node cause the one or more processors to:
receive, from a second core network node, a subscription request to a Quality of Service (QOS) Monitoring event for a QoS flow bound to an application, the subscription request including an indication to receive a QoS monitoring report on a QoS flow bound to an application and associated with a default QoS rule;
in response to the subscription request, cause sending to a user plane function of a request for QoS monitoring for the QOS Flow associated with the default QoS rule when no Policy Control Charging (PCC) rule is identified for the application or no PCC rule with QoS monitoring enabled is found for the application, the request including an indication that the QoS Flow is associated with the default QoS Rule; and
the indication is to be provided to the second network node in direct event notification when reporting by the user plane function the QoS monitoring event to the second network node.
